(19) United States
(12) Patent Application Publication
(10) Pub. No.: US 2020/0031460 A1
(43) Pub. Date: Jan. 30, 2020

(54) UNMANNED AERIAL VEHICLE FOR DELIVERING CARGO

(71) Applicant: Walmart Apollo, LLC, Bentonville, AR (US)

(72) Inventor: Andrew B. MILLHOUSE, Gilbert, AZ (US)

(21) Appl. No.: 16/516,529

(22) Filed: Jul. 19, 2019

Related U.S. Application Data
(60) Provisional application No. 62/711,778, filed on Jul. 30, 2018.

(51) Int. Cl. B64C 27/50; G06Q 10/08

(52) U.S. Cl. CPC B64C 27/50; G06Q 10/083; B64C 2201/128; B64C 2201/027; B64C 2201/042; B64C 2201/108

(57) ABSTRACT

Disclosed herein are aspects of an unmanned aerial vehicle (UAV). In one embodiment, the UAV includes a container body having a cargo bay configured to hold cargo, and a plurality of rotor assemblies coupled to the container body. Each rotor assembly is configured to provide the container body with propulsion. A control system may be held by the container body and operatively connected to the rotor assemblies. The control system may be configured to fly the container body to a destination. The rotor assemblies may be moveable between a flight configuration and a shipping configuration. In the flight configuration, the rotor assemblies may extend outward from the container body such that the rotor assemblies are positioned to propel the container body through the air. In the shipping configuration, the rotor assemblies may be folded to the container body such that the container body is configured to be shipped to a destination.

### BACKGROUND

Unmanned aerial vehicles (UAVs), sometimes referred to as drones, have been developed for a wide range of applications, such as photography, video photography, recreation, exploration, inspection, and other applications. One emerging application of UAVs is the delivery of cargo to a delivery destination. For example, UAVs are being developed to deliver retail and other products that have been purchased online directly to the customer's home or business. But, the round trip distance between the source of the cargo and the delivery destination may be greater than the two-way range of many UAVs such that the UAV is not capable of flying back to the source after delivering the cargo. Accordingly, UAV's may not be suitable for delivery to some customers.

### SUMMARY

In one aspect, the disclosure provides an unmanned aerial vehicle (UAV). In one embodiment, the UAV includes a container body having a cargo bay configured to hold cargo, and a plurality of rotor assemblies coupled to the container body. Each rotor assembly is configured to provide the container body with propulsion. A control system may be held by the container body and operatively connected to the rotor assemblies. The control system may be configured to fly the container body to a destination. The rotor assemblies may be moveable between a flight configuration and a shipping configuration. In the flight configuration, the rotor assemblies may extend outward from the container body such that the rotor assemblies are positioned to propel the container body through the air. In the shipping configuration, the rotor assemblies may be folded to the container body such that the container body is configured to be shipped to a destination.

In another aspect, the disclosure provides a method for delivering cargo. In one embodiment, the method includes flying an unmanned aerial vehicle (UAV) having a container body comprising a cargo bay to a first destination. The cargo bay is configured to hold cargo. The method may include folding rotor assemblies of the UAV to the container body of the UAV such that the rotor assemblies are in a shipping configuration wherein the container body is configured to be shipped. The method may include shipping the container body of the UAV to a second destination with the rotor assemblies in the shipping configuration.

In another aspect, the disclosure provides a cargo delivery system. In one embodiment, the cargo delivery system includes a base station and an unmanned aerial vehicle (UAV) that includes a container body having a cargo bay configured to hold cargo. The UAV may include a plurality of rotor assemblies coupled to the container body and configured to provide the container body with propulsion. The UAV may include a control system held by the container body and operatively connected to the rotor assemblies. The control system may be configured to fly the container body between the base station and delivery locations. The rotor assemblies may be moveable between a flight configuration and a shipping configuration. In the flight configuration, the rotor assemblies may extend outward from the container body such that the rotor assemblies are positioned to propel the container body through the air. In the shipping configuration, the rotor assemblies may be folded to the container body such that the container body is configured to be shipped.

This Summary is provided to introduce a selection of concepts in a simplified form that are further described below in the Detailed. Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a plan view illustrating one embodiment of an unmanned aerial vehicle (UAV) according to principles of the disclosure;

FIG. 2 is a side elevational view of the UAV shown in FIG. 1 illustrating the UAV in an exemplary flight configuration according to principles of the disclosure;

FIG. 3 is a plan view of the UAV shown in FIGS. 1 and 2 illustrating the UAV in an exemplary shipping configuration according to principles of the disclosure.

FIG. 4 is a side elevational view of the UAV shown in FIG. 3 illustrating the UAV in the exemplary shipping configuration shown in FIG. 3.

FIG. 5 is a front elevational view of the UAV shown in FIGS. 3 and 4 illustrating the UAV in the exemplary shipping configuration shown in FIGS. 3 and 4,

FIG. 6 is a plan view of another embodiment of a UAV according to principles of the disclosure.

FIG. 7 is a side elevational view of another embodiment of a UAV according to principles of the disclosure.

FIG. 8 is a side elevational view of the UAV shown in FIG. 7 illustrating an exemplary cover of the UAV in a closed position according to principles of the disclosure.

FIG. 9 is a plan view illustrating another embodiment of a UAV according to principles of the disclosure;

FIG. 10 is a side elevational view of the UAV shown in FIG. 9 illustrating the UAV in an exemplary flight configuration according to principles of the disclosure;

FIG. 11 is a front elevational view of the UAV shown in FIGS. 9 and 10 illustrating the UAV in an exemplary shipping configuration according to principles of the disclosure.

FIG. 12 is an exemplary flowchart illustrating a method for delivering cargo according to principles of the disclosure.

FIG. 13 is a block diagram illustrating an embodiment of a cargo delivery system according to principles of the disclosure.

Corresponding reference characters indicate corresponding parts throughout the drawings.

### DETAILED DESCRIPTION

Aspects of the disclosure provide an unmanned aerial vehicle (UAV) that includes a container body having a cargo bay configured to hold cargo, and a plurality of rotor assemblies coupled to the container body. The rotor assemblies may be moveable between a flight configuration and a shipping configuration. In the flight configuration, the rotor assemblies may extend outward from the container body such that the rotor assemblies are positioned to propel the container body through the air. In the shipping configuration, the rotor assemblies may be folded to the container body such that the container body is configured to be shipped to a destination. Embodiments shown and described herein may enable UAVs to be used to deliver and/or retrieve cargo when the round trip distance to the delivery and/or retrieval destination and back is greater than the two-way range of the UAV.

Referring to the figures, examples of the disclosure enable a UAV, a method for delivering cargo, and a cargo delivery system.

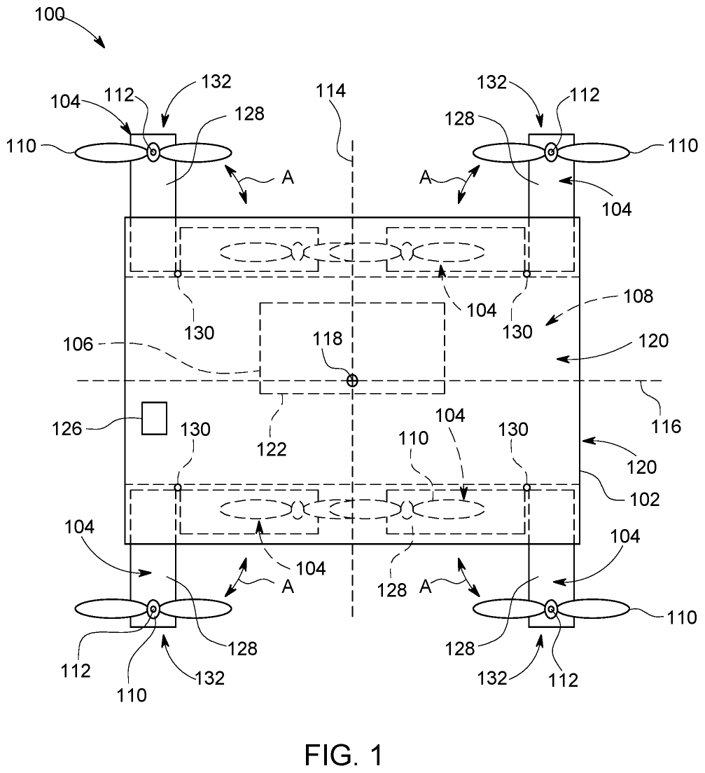

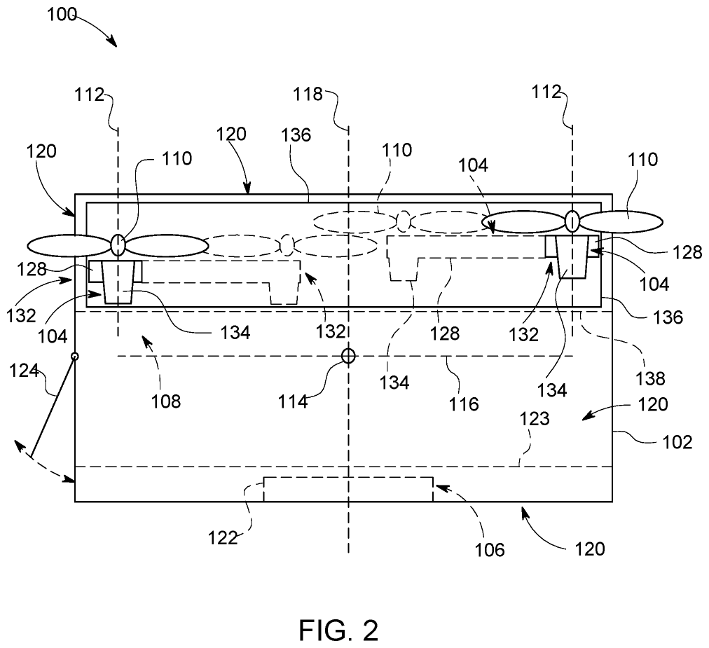

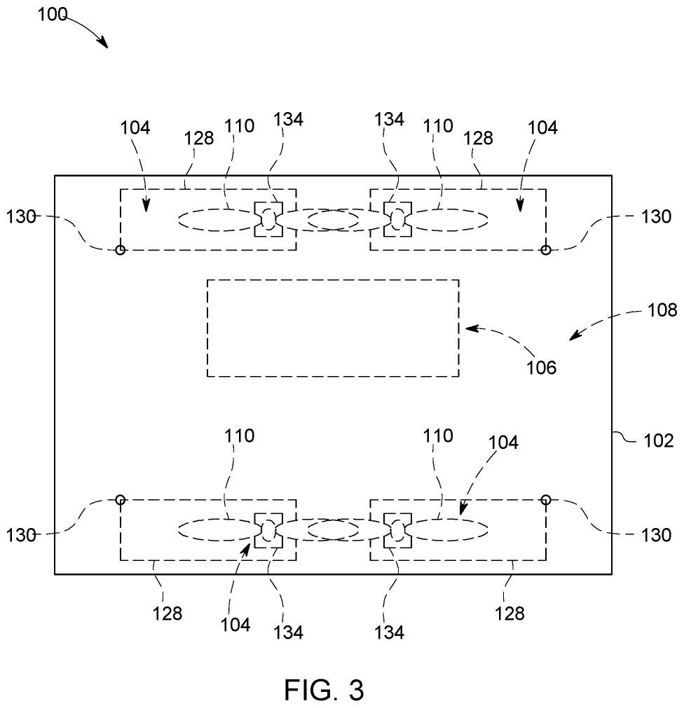

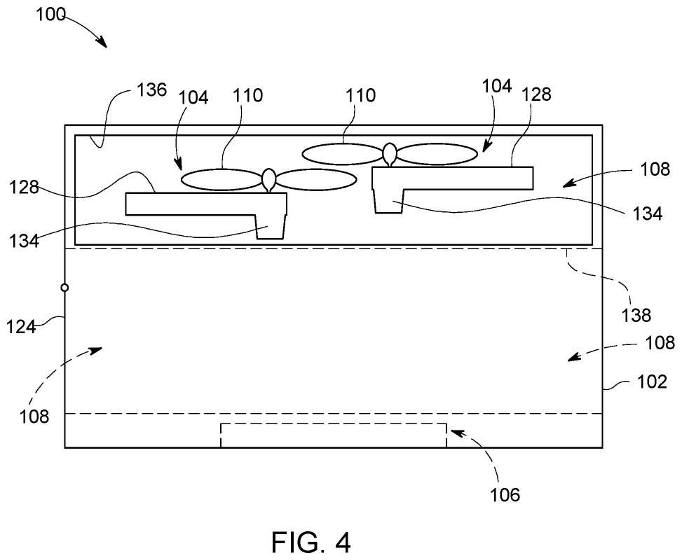

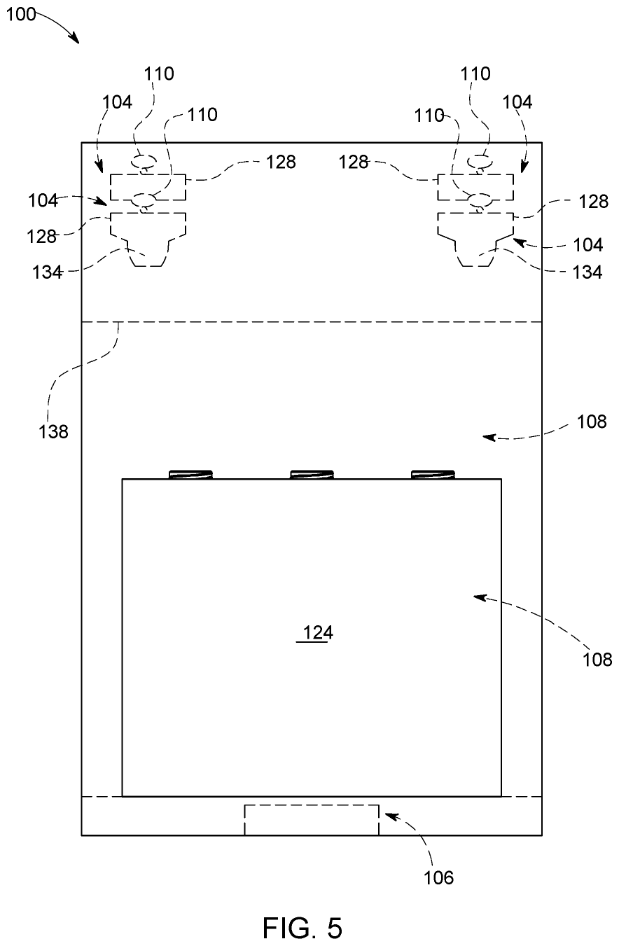

Referring now to FIGS. 1 and 2, there is shown one embodiment of a 100. The UAV 100 includes a container body 102, a plurality of rotor assemblies 104 coupled to the container body 102, and a control system 106 held by the container body 102. The container body 102 includes a cargo bay 108 that is configured to hold cargo (e.g., a retail or wholesale product that is intended for delivery). As will be described in more detail below, the rotor assemblies 104 are moveable between a flight configuration (shown in FIGS. 1 and 2) and a shipping configuration (shown in FIGS. 3-5). In the flight configuration, the rotor assemblies 104 extend outward from the container body 102 such that the rotor assemblies are positioned to propel the container body 102 through the air. In the shipping configuration, the rotor assemblies 104 are folded to the container body 102 such that the container body 102 is configured to be shipped to a destination using a shipping carrier (e.g., United Parcel Service (UPS), FedEx, the United States Postal Service (USPS), UHL, etc.). The shipping configuration of the rotor assemblies 104 is shown in FIGS. 1 and 2 in phantom for clarity.

In the exemplary embodiment, the UAV 100 is a rotorcraft. The rotor assemblies 104 include propellers 110 that rotate to generate lift and/or thrust for the UAV 100 and thereby move fly, propel, etc.) the container body 102 through the air. To affect the motion of the UAV 100 through the air, the propeller 110 of each rotor assembly 104 may rotate at approximately the same rate of rotation as compared other rotor assemblies 104 (to thereby generate approximately the same amount of lift and/or thrust) and/or may rotate at a different rate of rotation as compared to other rotor assemblies 104. (to thereby generate a different amount of lift and/or thrust). For example, the propeller 110 of one or more rotor assemblies 104 may rotate at a different rate of rotation as compared to one or more other rotor assemblies 104 to change the orientation of (e.g., rotate) the UAV 100.

The propellers 110 of the rotor assemblies 104 rotate about axes of rotation 112. The axes of rotation 112 may be arranged approximately parallel to each other, as is shown in FIGS. 1 and 2. In some embodiments, the axis of rotation 112 of the propeller 110 of one or more of the rotor assemblies 104 is fixed at, or selectively moveable to (for example using the control system 106), a non-parallel angle relative to the axis of rotation 112 of one or more other rotor assemblies 104, for example to affect the motion of the UAV 100.

The rotor assemblies 104 may enable the UAV 100 to move about any number of degrees of freedom, such as, but not limited to, one or more, two or more, three or more, four or more, five or more, six or more, and/or the like. The rotor assemblies 104 may enable the UAV 100 to rotate about any number of axes of rotation (e.g., a pitch axis 114, a roll axis 116, and/or a yaw axis 118). The UAV 100 may move along any number of dimensions, for example along an X axis that is approximately parallel to the pitch axis 114 of the UAV 100, a Y axis that is approximately parallel to the roll axis 116 of the UAV 100, and a Z axis that is approximately parallel to the yaw axis 118 of the UAV 100. The rotor assemblies 104 of the UAV 100 may enable the UAV 100 to take off and/or land vertically.

Although the exemplary embodiment of the UAV 100 includes four rotor assemblies 104 (sometimes referred to as a “quadcopter”), the UAV 100 may include any number of rotor assemblies 104, such as, but not limited to, two, three, four, five, six, seven, eight, or more rotor assemblies 104. One alternative example of the UAV 100 is a helicopter arrangement that includes one or more main rotor assemblies 104 and one or more control rotor assemblies 104.

The control system 106 includes various components for controlling the flight and/or other operations of the UAV 100. For example, the control system 106 may include a flight control unit, one or more navigation units (e.g., a global positioning system (GPS), etc.), one or more communication units (e.g., wireless communication unit, cellular communication units, radio communication units, etc.), one or more sensors, one or more electrical power units, and/or the like. Examples of sensors of the UAV 100 include, but are not limited to, vision and/or image sensors (e.g., imaging devices capable of detecting visible, infrared, and/or ultraviolet light, night vision cameras, other cameras, radar, sonar, etc.), location sensors (e.g., GPS sensors, mobile device transmitters enabling location triangulation, etc.), proximity and/or range sensors (e.g., ultrasonic sensors, lidar, time-of-flight and/or depth cameras, etc.), inertial sensors (accelerometers, gyroscopes, magnetometers, inertial measurement units, etc.), altitude sensors, attitude sensors (e.g., compasses, etc.), pressure sensors (e.g., barometers), audio sensors (e.g., microphones, etc.), field sensors, (e.g., magnetometers, electromagnetic sensors, etc.), WiFi sensors, and/or the like.

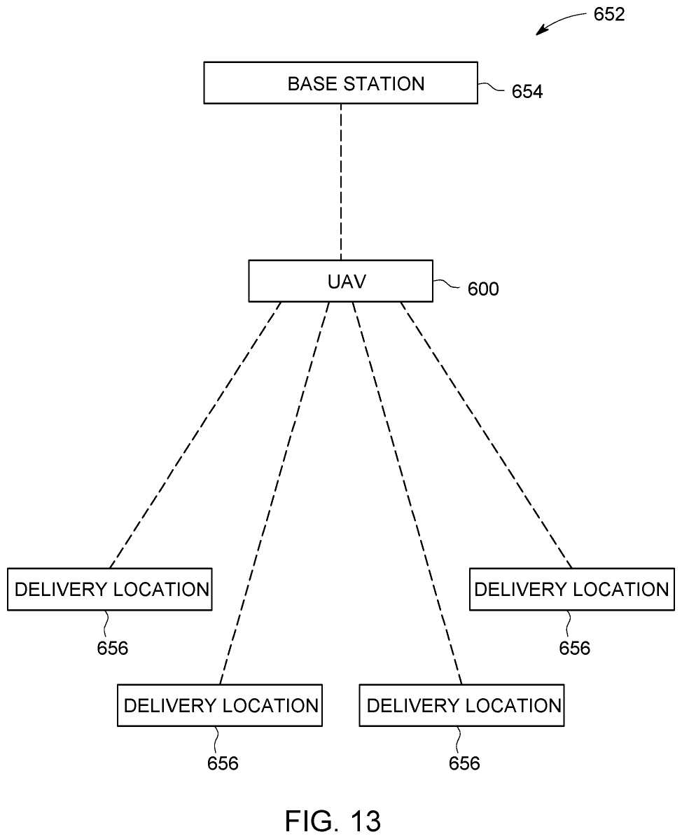

The control system 106 of the UAV 100 may enable the UAV 100 to operate autonomously. For example, the UAV 100 may be capable of autonomously flying to a destination to deliver cargo to the destination and/or pickup cargo from the destination. The UAV 100 may operate autonomously by following a set of pre-programmed instructions, for example. In some embodiments, the UAV 100 may be controlled using a remote controller (not shown) that communicates with the UAV 100 wirelessly, for example from a base station (e.g., the base station 654 shown in FIG. 13). In combination with a remote controller, the control system 106 of the UAV 100 may enable the UAV 100 to operate semi-autonomously in some embodiments. For example, one or more commands from the remote controller may initiate a sequence of autonomous or semi-autonomous actions by the UAV 100 in accordance with one or more pre-programmed instructions.

In the exemplary embodiment, the entirety of the control system 106 is shown as being held within the cargo bay 108 of the container body 102. But, some components or the entirety of the control system 106 may be located outside of the cargo bay 108. In one example, the entirety of the control system 106 is contained within a housing (not shown) that is mounted to an exterior 120 of the container body 102. In another example, one or more cameras, a communication antenna, and/or other sensors of the control system 106 are mounted to the exterior 120 of the container body 102 while the flight control, navigation, and communication units are held within the cargo bay 108. Various components of the control system 106 may be housed within a common housing. For example, in the exemplary embodiment, the control system 106 is housed within a housing 122 that is mounted to the container body 102 within the cargo bay 108. Any components of the control system 106 that are held within the cargo bay 108 may be separated from the remainder of the cargo bay 108 by an optional partition (e.g., the false bottom 124 shown in FIG. 2) to facilitate protecting the cargo and the control system 106 from each other.

As described above, the cargo bay 108 of the container body 102 is configured to hold cargo for delivery to a destination. The cargo bay 108 may be configured to hold any cargo that is suitable for delivery. Examples of cargo held by the cargo bay 108 include, but are not limited to, retail or wholesale products (e.g., purchased online, over the telephone, or over facsimile), building, remodeling, and/or construction supplies, medical supplies, and/or the like. Although shown as having a rectangular parallelepiped shape, the cargo bay 108 may have any size, shape, and/or the like. Moreover, the container body 102 may be constructed from any material(s) to facilitate supporting cargo having any weight. The size, shape, and/or the like of the cargo bay 108, as well as the material construction of the container body 102 and the lifting power of the rotor assemblies 104, may be configured to carry a specific type of cargo or may be configured more generically to carry a variety of cargos having different sizes, shapes, and/or weights. Examples of material(s) that may be used to construct the container body 102 include, but are not limited to, a composite material (e.g., carbon fiber, fiberglass, Kevlar®, etc.), a plastic, aluminum, titanium, magnesium, and/or the like.

As is also briefly described above, the container body 102 is configured to be shipped using a shipping carrier when the rotor assemblies 104 are in the shipping configuration (shown in FIGS. 3-5). The shape of the exterior 120 of the container body 102 and the materials used to construct the container body 102 may be selected to facilitate shipping the container body 102 using the shipping carrier. In the exemplary embodiment, the exterior 120 of the container body 102 is shown as having a rectangular parallelepiped shape, but the exterior 120 additionally or alternatively may include any other shape that enables the container body 102 to be shipped using a shipping carrier. Optionally, the container body 102 is provided with an aerodynamic shape (e.g., a low drag shape, a shape that provides lift, etc.) and/or includes one or more aerodynamic appendices (e.g., a fin, a tail, a wing, etc.) to facilitate movement of the container body 102 through the air during flight of the UAV 100.

Optionally, the container body 102 includes one or more cargo bay doors 124 (not visible in FIG. 2) that closes the cargo bay 108, for example to protect the cargo during flight of the UAV 100. Although shown as having a single cargo bay door 124 on a front side 126 of the container body 102, the container body 102 may include any number of cargo bay doors 124 that may each have any location along the exterior 120 of the container body 102. The cargo bay door 124 may be manually operated and/or may be automatic. For example, an individual may manually open the cargo bay door 124 to retrieve cargo from within, or place cargo into, the cargo bay 108. In addition or alternatively to being manually operated, the control system 106 may automatically open and/or close the cargo bay door 124. For example, the control system 106 may automatically open the cargo bay door 124 upon arrival at a destination (whether the UAV 100 has flown or been shipped to the destination) or upon being prompted by an individual (e.g., using a button and/or other input device of the UAV 100). Suitable actuators (not shown, e.g., electric motors, servos, solenoids, screw-type actuators, other linear actuators, etc.) may be provided to enable the control system 106 to automatically open and close the cargo door 124.

The container body 102 may include shipping information on the exterior 120 of the container body 102. The shipping information may be dynamic information or static information. Examples of dynamic shipping information include, but are not limited to, an electronic ink label, a dynamic QR code, and/or the like. Examples of static shipping information include, but are not limited to, a bar code, a static QR code, an address, and/or the like. The shipping information may be printed directly on an exterior surface of the exterior 120 of the container body 102 or may be printed on a label that is affixed to an exterior surface of the exterior 120 of the container body 102. In exemplary embodiment, the exterior 120 of the container body 102 includes an electronic ink label 126. In some embodiments, a shipping label is provided within the cargo bay 108 for application to the exterior 120 of the container body 102 by a recipient of the UAV 100.

FIGS. 1 and 2 illustrate the rotor assemblies 104 of the UAV 100 in the flight configuration, wherein the rotor assemblies 104 extend outward from the container body 102. Each rotor assembly 104 includes an arm 128 that is connected to the container body 102 at a hinge 130. The arm 128 extends a length outward from the hinge 130 to an end 132. In the exemplary embodiment, the propeller 110 of each rotor assembly 104 is positioned at the end 132 of the corresponding arm 128. But, the propeller 110 of each rotor assembly 104 may be located at any other location along the length of the corresponding arm 128 that enables the propeller 110 to generate lift. Each rotor assembly 104 includes an electric motor 134 that is connected to the corresponding propeller 110 such that the electric motor 134 drives rotation of the corresponding propeller 110. In addition or alternatively, other actuators (e.g., a combustion engine, etc.) may be used to drive rotation of the propellers 110. Operation of the electric motors 134 are controlled by the control system 106 to control flight of the UAV 100.

In the flight configuration shown in FIGS. 1 and 2, the arms 128 of the rotor assemblies 104 extend outward from the container body 102 such that the propellers 110 are positioned to enable flight of the UAV 100 (i.e., to propel the container body 102 through the air). As briefly described above, the rotor assemblies 104 are moveable from the flight configuration to the shipping configuration (shown in FIGS. 1 and 2 in phantom for clarity) to prepare the container body 102 for shipping. For example, the arms 128 of the rotor assemblies 104 are moveable (i.e., rotatable) about the hinges 130 along arcs A (not visible in FIG. 2) toward the container body 102. When moved along the arcs A toward the container body 102 the arms 128 fold inward to the container body 102 to the shipping configuration shown in phantom in FIGS. 1 and 2. In the embodiment shown in FIGS. 1-5, the arms 128 fold inward through a corresponding opening 136 (not visible in FIG. 1) of the container body 102 such that the rotor assemblies 104 are contained entirely within the cargo bay 108 of the container body 102 in the shipping configuration.

In the exemplary embodiment, the container body 102 includes two openings 136 (only one opening is visible in the FIGS.), each of which receives two rotor assemblies 104 therethrough when the rotor assemblies 104 are moved from the flight configuration to the shipping configuration. But, the container body 102 may include any number of the openings 136, each of which may receive any number of the rotor assemblies 104 therethrough. For example, in sonic embodiments, the container body 102 includes a dedicated opening 136 for each rotor assembly 104.

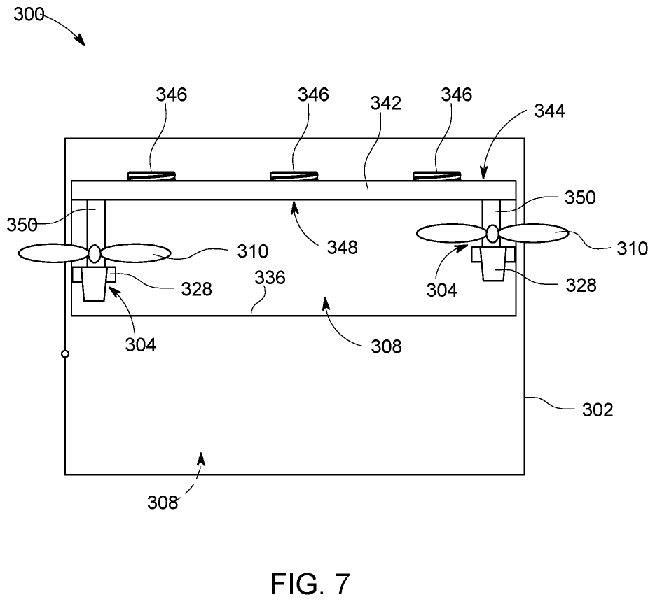

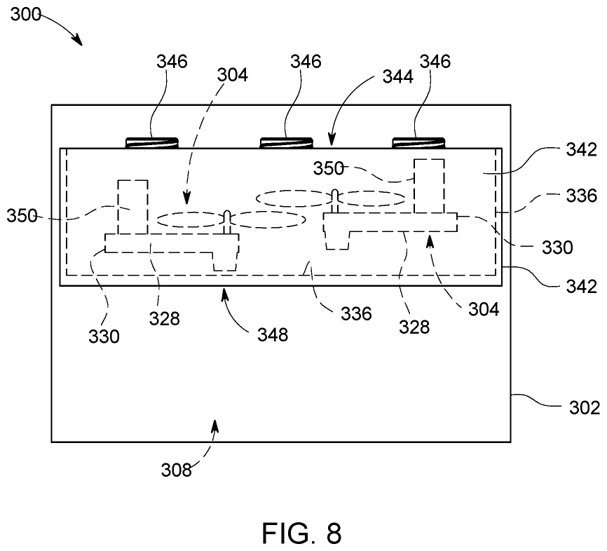

Referring now to FIGS. 3-5, the arms 128 of the rotor assemblies 104 are folded into the shipping configuration. For example, the arms 128 of the rotor assemblies 104 are folded to the container body 102 such that the rotor assemblies 104 are contained entirely within the cargo bay 108 of the container body 102, as is shown in FIGS. 3-5. When contained entirely within the cargo bay 108 as shown in FIGS. 3-5, the arms 128, the electric motors 134, and the propellers 110 are positioned to be protected by the container body 102 during shipping. Accordingly, the container body 102 is ready for shipping once the rotor assemblies 104 have been folded into the shipping configuration shown in FIGS. 3-5. Optionally, the container body 102 includes one or more covers (e,g., the cover 342 shown in FIGS. 7 and 8 and described below) that at least partially closes one or more corresponding openings 136 of the container body 102 to cover and thereby provide protection to the rotor assemblies 104 during shipping. The container body 102 optionally includes a partition 138 (e.g., a false top) within the cargo bay 108 to facilitate protecting the rotor assemblies 104 during shipping. Optionally, the container body 102 is loaded into another container (not shown) for shipping.

Movement of the rotor assemblies 104 between the shipping configuration and the flight configuration may be automatic and/or may be manual. For example, an individual may manually fold the rotor assemblies 104 inward from the flight configuration to the shipping configuration to prepare the UAV 100 for shipping. Moreover, an individual may manually unfold the rotor assemblies from the shipping configuration to the flight configuration to prepare the UAV 100 for flight, for example. In addition or alternatively to being manually folded and/or unfolded, the control system 106 may automatically fold the rotor assemblies 104 between the flight configuration and the shipping configuration. For example, the control system 106 may automatically fold the rotor assemblies 104 outward from the shipping configuration to the flight configuration to prepare the UAV 100 for flight (e.g., upon sensing that the UAV 100 has arrived at a destination or upon being prompted by an individual using a button and/or other input device of the UAV 100). Moreover, the control system 106 may automatically fold the rotor assemblies 104 inward from the flight configuration to the shipping configuration to prepare the UAV 100 for shipping, for example upon sensing that the UAV 100 has arrived at a destination or upon being prompted by an individual. Suitable actuators (not shown, e.g., electric motors, servos, solenoids, screw-type actuators, other linear actuators, etc.) may be provided to enable the control system 106 to automatically move the rotor assemblies 104 between the flight configuration and the shipping configuration.

In one example, the UAV 100 flies to a destination (e.g., a home or business) to deliver cargo to the destination. Once the UAV 100 arrives at the destination, the cargo is retrieved from the cargo bay 108 of the container body 102. At the destination, the rotor assemblies 104 are folded inward from the flight configuration into the shipping configuration, whether manually by an individual at the destination or automatically by the control system 106. The container body 102 of the UAV 100 is then ready to be shipped back to the source of the cargo and may be picked up by the shipping carrier at the destination or may be brought from the destination to the shipping carrier (e.g., directly to the shipping carrier or to a drop-off location) by an individual (e.g., the individual that received the cargo). In some embodiments, the control system 106 automatically senses that the rotor assemblies 104 have been folded into the shipping configuration and communicates to the shipping carrier that the UAV 100 is ready to be shipped back to the source of the cargo.

In another example, the UAV 100 flies to a destination (e.g., a home or business) to retrieve cargo from the destination and deliver it to another destination to return the cargo to an original source of the cargo). Upon arrival of the UAV 100 at the retrieval destination, the cargo is loaded the cargo bay 108 of the container body 102 and the rotor assemblies 104 are folded inward from the flight configuration into the shipping configuration, whether manually by an individual at the retrieval destination or automatically by the control system 106. The container body 102 of the UAV 100 is then ready to be shipped to the delivery destination. Once ready for shipping, the UAV 100 may be picked up by the shipping carrier at the retrieval destination or may be brought from the retrieval destination directly to the shipping carrier or to a drop-off location of the shipping carrier by an individual (e.g., the individual that loaded the cargo into the cargo bay 108). Optionally, the control system 106 automatically senses that the rotor assemblies 104 have been folded into the shipping configuration and communicates to the shipping carrier that the UAV 100 is ready to be shipped to the delivery destination.

Another example includes shipping the UAV 100 to a destination (e.g., a home or business) to deliver cargo to the destination and/or retrieve cargo from the destination. Once the UAV 100 arrives at the destination, the cargo is retrieved from, and/or loaded into, the cargo bay 108 of the container body 102. At the destination, the rotor assemblies 104 are folded outward from the shipping configuration into the flight configuration, whether manually by an individual at the destination or automatically by the control system 106. The container body 102 of the UAV 100 is then ready to fly to another destination (e.g., a return destination, a source destination, etc.).

In yet another example, the UAV 100 is either shipped or flies to a destination (e.g., a home or business) to deliver cargo to the destination and/or retrieve cargo from the destination. Once the UAV 100 arrives at the destination, the cargo is retrieved from, and/or loaded into, the cargo bay 108 of the container body 102. If the UAV 100 is not already in the flight configuration, the rotor assemblies 104 of the UAV 100 are manually or automatically moved to the flight configuration. The UAV 100 then flies to a group pickup station (e.g., a shipping carrier drop-off location, an outbound bin at a retail or wholesale business, an outbound bin at a distribution center, etc.) for shipment from the group pickup location to another destination (e.g., a return destination, a source destination, etc.)

In still another example, the UAV 100 flies to a group pickup station (e.g., a shipping carrier drop-off location, an outbound bin at a retail or wholesale business, an outbound bin at a distribution center, etc.). At the group pickup station, the rotor assemblies 104 are folded inward, whether manually or automatically, from the flight configuration into the shipping configuration. The UAV 100 is then shipped to a destination, such as a home or business, for delivering cargo to the destination and/or retrieving cargo from the destination. The UAV 100 is then either shipped or flies to another destination, for example a return destination or a source destination.

Another example includes flying the UAV 100 to a group pickup station, such as a shipping carrier drop-off location, an outbound bin at a retail or wholesale business, an outbound bin at a distribution center, etc. At the group pickup station, the rotor assemblies 104 are folded inward, whether manually or automatically, from the flight configuration into the shipping configuration. The UAV 100 is then shipped to a destination, such as a home or business, for delivering cargo to the destination and/or retrieving cargo from the destination. Once the cargo has been delivered and/or retrieved, the rotor assemblies 104 of the UAV 100 are manually or automatically moved to the flight configuration and the UAV 100 flies to a group pickup station (e.g., the same group pickup station or a different group pickup location). The UAV 100 is then either shipped to another destination, such as a return destination or a source destination.

As best seen in FIGS. 1, 2, 4, and 5, the arms 128 of the rotor assemblies 104 do not include any joints along the length of the arms 128 between the hinges 130 and the ends 132. Rather, in the exemplary embodiment of FIGS. 1-5, the hinge 130 is the only joint of each arm 128. But, the arm 128 of each rotor assembly 104 may include any number of joints between the corresponding hinge 130 and end 132 for providing any number of different folding configurations of the arms 128.

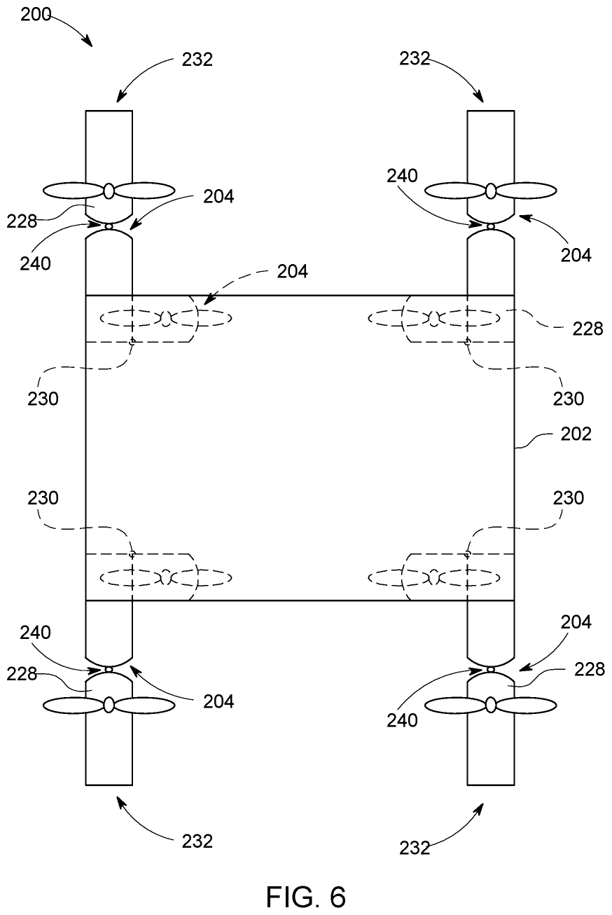

For example, FIG. 6 illustrates another embodiment of a UAV 200. The UAV 200 includes a plurality of rotor assemblies 204 that each include an arm 228 that is connected to a container body 202 of the UAV 200 at a hinge 230. The arm 228 extends a length outward from the hinge 230 to an end 232. Each arm 228 includes another hinged joint 240 positioned along the length of the arm 228 between the hinge 230 and the end 232. The arm 228 of each rotor assembly 204 is moveable between a flight configuration (shown in solid lines in FIG. 6) and a shipping configuration (shown in phantom lines in FIG. 6). In the flight configuration, the arms 228 of the rotor assemblies 204 extend outward from the container body 202 such that the rotor assemblies 204 are positioned to enable flight of the UAV 200. The arms 228 of the rotor assemblies 204 are moveable (i,e., rotatable) about the hinges 230 and 240 toward the container body 202 such that the arms 228 fold inward to the container body 102 to the shipping configuration shown in phantom in FIG. 6. Although only one hinged joint 240 is shown along the length of the arms 228 between the hinge 230 and the end 232, each arm 228 may include any number of hinged joints for providing a variety of different folding configurations of the arms 228.

Referring again to the embodiment of FIGS. 1-5, as described above, the container body 102 optionally includes one or more covers that at least partially closes the openings 136 of the container body 102 to cover and thereby provide protection to the rotor assemblies 104 during shipping. For example, and referring now to FIGS. 7 and 8, a UAV 300 includes a plurality of rotor assemblies 304 that each include an arm 328 that is connected to a container body 302 of the UAV 300 at a hinge 330. The arms 328 of each rotor assembly 304 is moveable between a flight configuration (shown in FIG. 7) and a shipping configuration (shown in FIG. 8). In the flight configuration, the arms 328 of the rotor assemblies 304 extend outward from the container body 302 such that the rotor assemblies 304 are positioned to enable flight of the UAV 300.

The rotor assemblies 304 are moveable from the flight configuration to the shipping configuration to prepare the container body 302 for shipping. For example, the arms 328 of the rotor assemblies 304 are moveable (i.e., rotatable) about the hinges 330 toward the container body 302 such that the arms 328 fold inward through a corresponding opening 336 of the container body 102. When folded into the shipping configuration as shown in FIG. 8, the rotor assemblies 304 are contained entirely within a cargo bay 308 of the container body 302.

The container body 302 includes a cover 342 that closes the opening 336. The container body 302 may include any number of and any type(s) of covers 342 for closing any number of the openings 336. Each cover 342 may be a manually operated cover, a mechanically controlled automatic cover, and/or an electronically controlled automatic cover. In the exemplary embodiment of FIGS. 7 and 8, the cover 342 is a mechanically controlled automatic cover 342. For example, an end 344 of the cover 342 is rotatably connected to the container body 302 at a hinge 346 such that the cover 342 can rotate about the hinge 346 between an open position (shown in FIG. 7) when the rotor assemblies 304 are extended outward in the flight configuration and a closed position (shown in FIG. 8) when the rotor assemblies 304 are folded into the cargo bay 308 in the shipping configuration.

As shown in FIG. 7, an end 348 of the cover 342 that is opposite the hinged end 344 rests on standoffs 350 that extend upward from the arms 328 of the rotor assemblies 304 to hold the cover 342 in the open position when the rotor assemblies are extended outward in the flight configuration. As the arms 328 of the rotor assemblies 304 are folded through the opening 336 and into the cargo bay 308, the standoffs 350 hold the cover 342 open such that the arms 328 and propellers 310 of the rotor assemblies 304 clear the end 348 of the cover 342 and retract through the opening 336 into the cargo bay 308. Once the rotor assemblies 304 have been received into the cargo bay 308 in the shipping configuration, gravity and/or a suitable biasing mechanism (e.g., a spring) bias the cover 342 to the closed position shown in FIG. 8. During movement of the rotor assemblies 304 from the shipping configuration to the flight configuration, the propellers 310 (and/or a protective cage, not shown, that optionally surrounds the propellers 310) and the standoffs 350 engage the cover 342 to rotate the cover 342 about the hinged end 344 and thereby open the cover 342. Optionally, the cover 342 includes a latch (e.g., a magnetic latch, a snap latch, etc.) that holds the cover 342 in the closed position and which can be overcome by the force of the rotor assemblies 304 to open the cover 342 as the rotor assemblies 304 fold outward to the flight configuration.

Any other type of cover may be used in addition or alternatively to the cover 342. For example, another type of mechanically controlled automatic cover that may be used includes a cover (not shown) that is slideably connected to the container body 302 and is opened and closed by a cam mechanism on the arms 328 of the rotor assemblies 304. Another type of mechanically controlled automatic cover that may be used includes a swinging cover (not shown) that is rotatably connected to the container body 302 at a hinge similar to the cover 342, but that is capable of swinging both inward into the cargo bay 308 and outward away from the cargo bay 308. In such a swinging cover arrangement, the rotor assemblies 304 would retract far enough into the cargo bay 308 to clear a free end of the cover and enable the cover to swing closed. Other arrangements of mechanically controlled automatic covers may be used. Moreover, in some embodiments, a manually operated cover (not shown) may be provided that is manually opened and/or closed by an individual to enable the rotor assemblies 304 to move between the flight and shipping configurations (whether the rotor assemblies 304 are moved manually or automatically). In some embodiments, an electronically controlled automatic cover (not shown) is provided that is automatically opened and/or closed by a control system 306 of the UAV 300. Suitable actuators (e.g., electric motors, servos, solenoids, screw-type actuators, other linear actuators, etc.) may be provided to enable the control system 306 to automatically open and/or close the cover.

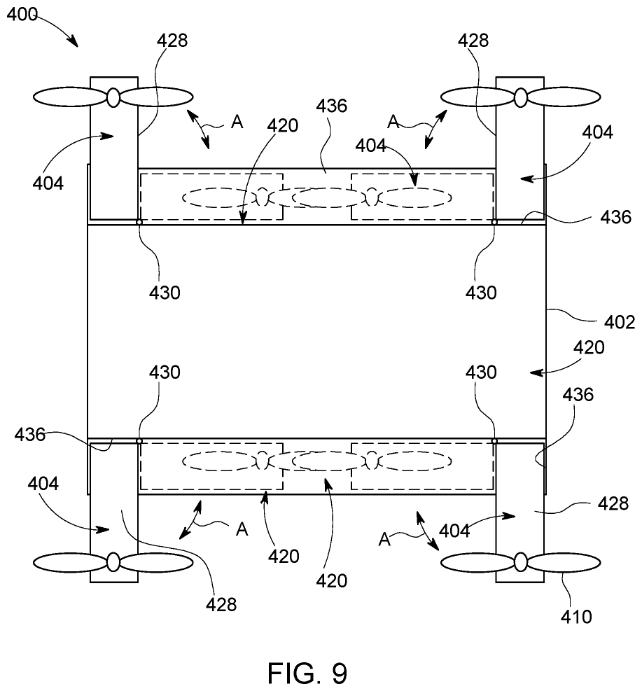

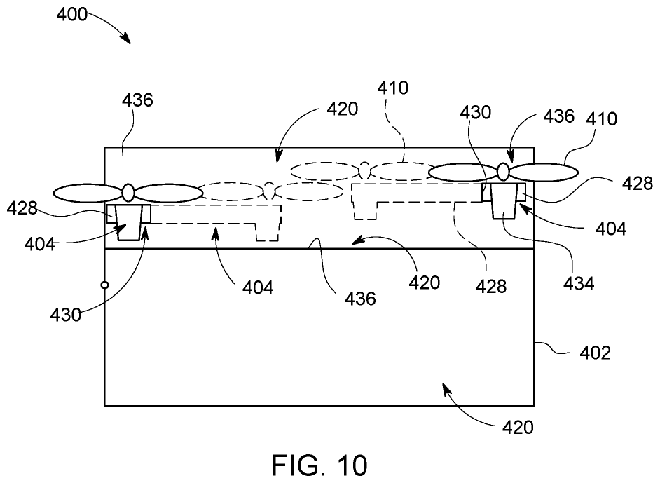

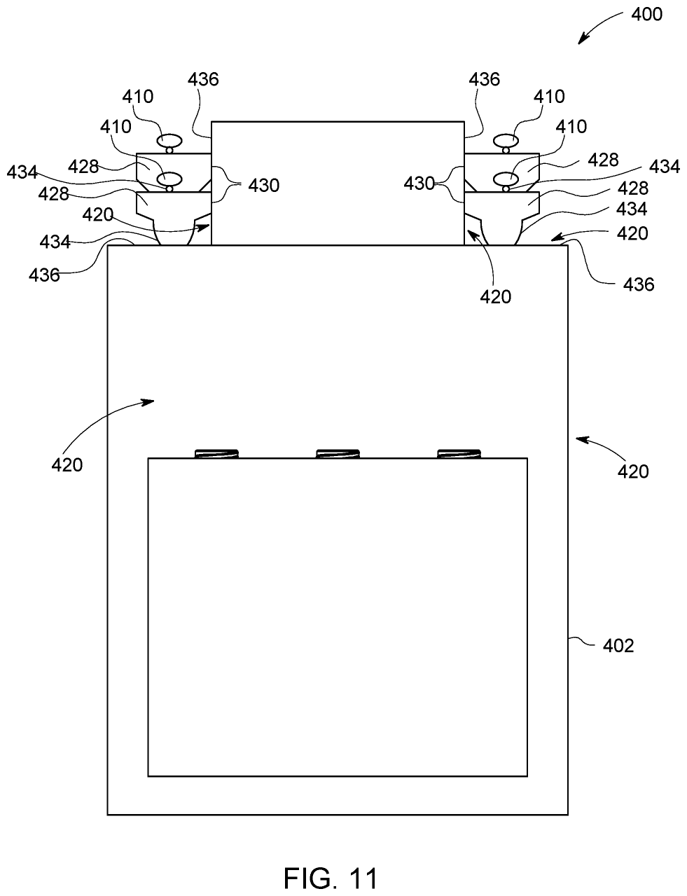

FIG. 9-11 illustrate another embodiment of a UAV 400 that includes rotor assemblies 404 that are moveable between a shipping configuration and a flight configuration. The rotor assemblies 404 are shown in the flight configuration in FIGS. 9 and 10 and are shown in the shipping configuration FIG. 11. The shipping configuration of the rotor assemblies 404 is also shown in phantom in FIGS. 9 and 10. Each rotor assembly 404 includes an arm 428 that is connected to a container body 402 of the UAV 400 at a hinge 430. In the flight configuration shown in FIGS. 9 and 10, the arms 428 of the rotor assemblies 404 extend outward from the container body 402 such that the rotor assemblies 404 are positioned to enable flight of the UAV 400. The rotor assemblies 404 are moveable from the flight configuration to the shipping configuration to prepare the container body 402 for shipping. For example, the arms 428 of the rotor assemblies 404 are moveable (i.e., rotatable) about the hinges 430 along arcs A (not visible in FIG. 10) toward the container body 402. When moved along the arcs A toward the container body 402 the arms 428 fold inward to the container body 402 to the shipping configuration shown in phantom in FIGS. 1 and 2. In the embodiment shown in FIGS. 9-11, the rotor assemblies 404 fold into corresponding recesses 436 that extend along an exterior 420 of container body 402. When the rotor assemblies 404 are in the shipping configuration, the rotor assemblies 404 are contained entirely within the corresponding recess 436.

In the exemplary embodiment, the container body 402 includes two recesses 436 (only one opening is visible in the FIGS.), each of which receives two rotor assemblies 404 therein in the shipping configuration of the rotor assemblies 404. But, the container body 402 may include any number of the recesses 436, each of which may receive any number of the rotor assemblies 404 therein. For example, in some embodiments, the container body 402 includes a dedicated recess 436 for each rotor assembly 404. The size, shape, and/or the like of each recess 436 may be complementary with the rotor assemblies 404.

Referring now to FIGS. 11, the arms 428 of the rotor assemblies 404 are folded into the shipping configuration. For example, the rotor assemblies 404 are folded to the container body 402 such that the rotor assemblies 404 are contained entirely within the corresponding recess 436 of the container body 402. When contained entirely within the corresponding recess 436, the arms 428, electric motors 434, and propellers 410 of the rotor assemblies 404 are positioned to be protected during shipping. Accordingly, the container body 402 is ready for shipping once the rotor assemblies 404 have been folded into the shipping configuration shown in FIG. 11. Optionally, the container body 402 includes one or more covers (not shown) that at least partially covers one or more corresponding recesses 436 of the container body 402 to cover and thereby provide protection to the rotor assemblies 404 during shipping.

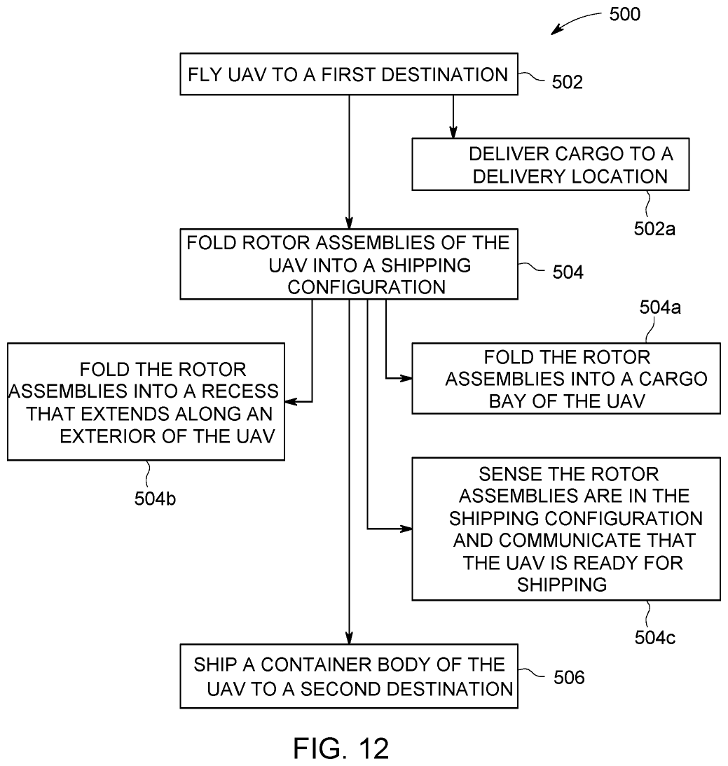

Referring now to FIG. 12, a method 500 for delivering cargo is shown. At operation 502, the method 500 includes flying a UAV having a container body that includes a cargo bay to a first destination. The cargo bay is configured to hold cargo. Optionally, the first destination is a delivery location and flying, at operation 502, the UAV to the first destination includes delivering, at operation 502a, the cargo to the delivery location.

At operation 504, the method 500 includes folding rotor assemblies of the UAV to the container body of the UAV such that the rotor assemblies are in a shipping configuration wherein the container body is configured to be shipped. In some examples, folding the rotor assemblies to the container body of the UAV, at operation 504, includes folding, at operation 504a, the rotor assemblies into the cargo bay of the container body such that the rotor assemblies are contained within the cargo bay when the rotor assemblies are in the shipping configuration. In other examples, folding, at operation 504, the rotor assemblies to the container body of the UAV includes folding, at operation 504b, the rotor assemblies into at least one recess that extends along an exterior of the container body such that the rotor assemblies are contained within the at least one recess when the rotors assemblies are in the shipping configuration. Optionally, the method 500 includes sensing, at operation 504c, when the rotor assemblies of the UAV are in the shipping configuration and communicating that the container body of the UAV is ready to be shipped.

At operation 506, the method 500 includes shipping the container body of the UAV to a second destination with the rotor assemblies in the shipping configuration. In some examples, the second destination is a delivery location and shipping, at operation 506, the container body of the UAV to the second destination includes delivering, for example, the cargo to the delivery location.

The operations of the method 500 may be performed in any order. For example, shipping, at operation 506, the container body of the UAV to the second destination may include shipping, at operation 506, the body of the UAV to the second destination before flying, at operation 502, the UAV to the first destination.

FIG. 13 is a block diagram illustrating an exemplary embodiment of cargo delivery system 600. The cargo delivery system 652 includes a base station 654, one or more UAVs 600 (e.g., the UAV 100 shown in FIGS. 1-5, the UAV 200 shown in FIG. 6, the UAV 300 shown in FIGS. 7 and 8, and/or the UAV 400 shown in FIGS. 9-11), and a plurality of delivery locations 656. Each UAV 600 includes a flight configuration and a shipping configuration. In the flight configuration, each UAV 600 is configured to fly from the base station 654 to the delivery locations 656, and vice versa. In the shipping configuration, each UAV 600 is also configured to be shipped from the base station 654 to the delivery locations 656, and vice versa. The base station 654 is configured to dispatch the UAV(s) 600 to the delivery locations 656. The base station 654 may be a source of cargo, a retail or wholesale business, a distribution center, a group pickup station, and/or the like.

### ADDITIONAL EXAMPLES

Alternatively, or in addition to the other examples described herein, examples include any combination of the following:

In one aspect, there is provided embodiments of an unmanned aerial vehicle (UAV). In one example, a UAV comprises a container body having a cargo bay configured to hold cargo; a plurality of rotor assemblies coupled to the container body, each rotor assembly being configured to provide the container body with propulsion; a control system held by the container body and operatively connected to the rotor assemblies, the control system being configured to fly the container body to a destination; and wherein the rotor assemblies are moveable between a flight configuration and a shipping configuration, wherein in the flight configuration the rotor assemblies extend outward from the container body such that the rotor assemblies are positioned to propel the container body through the air, and wherein in the shipping configuration the rotor assemblies are folded to the container body such that the container body is configured to be shipped to a destination.

In another example, the rotor assemblies are contained within the cargo bay of the container body when the rotor assemblies are in the shipping configuration.

In other examples, the container body comprises at least one opening, the rotor assemblies being movable from the flight configuration to the shipping configuration through the at least one opening such that the rotor assemblies are contained within the cargo bay of the container body in the shipping configuration.

In some examples, the container body comprises at least one recess extending along an exterior of the container body, the rotor assemblies being contained within the at least one recess when the rotor assemblies are in the shipping configuration.

In another example, the UAV further comprises an electronic ink shipping label on an exterior of the container body.

In still another example, the container body comprises at least one cover configured to at least partially close at least one of an opening or a recess of the container body such that the rotor assemblies are covered by the at least one cover when the rotor assemblies are in the shipping configuration.

In other examples, the control system is configured to automatically sense when the rotor assemblies are folded in the shipping configuration and communicate that the UAV is ready to be shipped to a destination.

In yet another example, the control system in configured to automatically move the rotor assemblies between the flight configuration and the shipping configuration.

In other examples, the control system is held within the cargo bay of the container body.

In another aspect, there may be disclosed a method for delivering cargo. In one example, the method comprises flying an unmanned aerial vehicle (UAV) having a container body comprising a cargo bay to a first destination, the cargo bay being configured to hold cargo; folding rotor assemblies of the UAV to the container body of the UAV such that the rotor assemblies are in a shipping configuration wherein the container body is configured to be shipped; and shipping the container body of the UAV to a second destination with the rotor assemblies in the shipping configuration.

In some examples, folding the rotor assemblies to the container body of the UAV comprises folding the rotor assemblies into the cargo bay of the container body such that the rotor assemblies are contained within the cargo bay when the rotor assemblies are in the shipping configuration.

In another example, folding the rotor assemblies to the container body of the UAV comprises folding the rotor assemblies into at least one recess that extends along an exterior of the container body such that the rotor assemblies are contained within the at least one recess when the rotors assemblies are in the shipping configuration.

In yet another example, the first destination is a delivery location and flying the UAV to the first destination comprises delivering the cargo to the delivery location.

In still another example, the second destination is a delivery location and shipping the container body of the UAV to the second destination comprises delivering the cargo to the delivery location.

In some examples, shipping the container body of the UAV to the second destination comprises shipping the body of the UAV to the second destination before flying the UAV to the first destination.

In other examples, flying the UAV to the first destination further comprises flying the UAV from the first destination to a group pickup station; folding the rotor assemblies of the UAV into the shipping configuration comprises folding the rotor assemblies into the shipping configuration at the group pickup station; and shipping the container body of the UAV to the second destination comprises shipping the body of the UAV from the group pickup station to the second destination.

In another example, the method further comprises sensing when the rotor assemblies of the UAV are in the shipping configuration and communicating that the container body of the UAV is ready to be shipped to the second destination.

In another aspect, there may be disclosed a cargo delivery system. In one example, the cargo delivery system comprises a base station; and an unmanned aerial vehicle (UAV) comprising a container body having a cargo bay configured to hold cargo, the UAV comprising a plurality of rotor assemblies coupled to the container body and being configured to provide the container body with propulsion, the UAV comprising a control system held by the container body and operatively connected to the rotor assemblies, the control system being configured to fly the container body between the base station and delivery locations, wherein the rotor assemblies are moveable between a flight configuration and a shipping configuration, wherein in the flight configuration the rotor assemblies extend outward from the container body such that the rotor assemblies are positioned to propel the container body through the air, and wherein in the shipping configuration the rotor assemblies are folded to the container body such that the container body is configured to be shipped.

In one example, the rotor assemblies of the UAV are contained within the cargo bay of the container body when the rotor assemblies are in the shipping configuration.

In another example, the container body of the UAV comprises at least one recess extending along an exterior of the container body, the rotor assemblies being contained within the at least one recess when the rotor assemblies are in the shipping configuration.

In yet another example, the control system of the UAV is communicatively coupled with the base station and is configured to automatically sense when the rotor assemblies are folded in the shipping configuration and communicate to the base station that the UAV is ready to be shipped.

At least a portion of the functionality of the various elements in the figures may be performed by other elements in the figures, or an entity (e.g., processor, web service, server, application program, computing device, etc.) not shown in the figures.

While the aspects of the disclosure have been described in terms of various examples with their associated operations, a person skilled in the art would appreciate that a combination of operations from any number of different examples is also within scope of the aspects of the disclosure.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the disclosure without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the disclosure should, therefore, be determined with reference to the appended claims, along with the full scope of equivalents to which such claims are entitled.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of” The phrase “one or more of the following: A, B, and C” means “at least one of A and/or at least one of B and/or at least one of C.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C, § 112(t), unless and until such claim limitations expressly use the phrase “means for” followed by a statement of function void of further structure.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. An unmanned aerial vehicle (UAV) comprising:
a container body having a cargo bay configured to hold cargo;
a plurality of rotor assemblies coupled to the container body, each rotor assembly being configured to provide the container body with propulsion;
a control system held by the container body and operatively connected to the rotor assemblies, the control system being configured to fly the container body to a destination; and
wherein the rotor assemblies are moveable between a flight configuration and a shipping configuration, wherein in the flight configuration the rotor assemblies extend outward from the container body such that the rotor assemblies are positioned to propel the container body through the air, and wherein in the shipping configuration the rotor assemblies are folded to the container body such that the container body is configured to be shipped to a destination.

2. The UAV of claim 1, wherein the rotor assemblies are contained within the cargo bay of the container body when the rotor assemblies are in the shipping configuration.

3. The UAV of claim 1, wherein the container body comprises at least one opening, the rotor assemblies being movable from the flight configuration to the shipping configuration through the at least one opening such that the rotor assemblies are contained within the cargo bay of the container body in the shipping configuration.

4. The UAV of claim 1, wherein the container body comprises at least one recess extending along an exterior of the container body, the rotor assemblies being contained within the at least one recess when the rotor assemblies are in the shipping configuration.

5. The UAV of claim 1, wherein the container body comprises at least one cover configured to at least partially close at least one of an opening or a recess of the container body such that the rotor assemblies are covered by the at least one cover when the rotor assemblies are in the shipping configuration.

6. The UAV of claim 1, wherein the control system is configured to automatically sense when the rotor assemblies are folded in the shipping configuration and communicate that the UAV is ready to be shipped to a destination.

7. The UAV of claim 1, wherein the control system in configured to automatically move the rotor assemblies between the flight configuration and the shipping configuration.

8. The UAV of claim 1, wherein the control system is held within the cargo bay of the container body.

9. A method for delivering cargo, the method comprising:
flying an unmanned aerial vehicle (UAV) having a container body comprising a cargo bay to a first destination, the cargo bay being configured to hold cargo;
folding rotor assemblies of the UAV to the container body of the UAV such that the rotor assemblies are in a shipping configuration wherein the container body is configured to be shipped; and
shipping the container body of the UAV to a second destination with the rotor assemblies in the shipping configuration.

10. The method of claim 9, wherein folding the rotor assemblies to the container body of the UAV comprises folding the rotor assemblies into the cargo bay of the container body such that the rotor assemblies are contained within the cargo bay when the rotor assemblies are in the shipping configuration.

11. The method of claim 9, wherein folding the rotor assemblies to the container body of the UAV comprises folding the rotor assemblies into at least one recess that extends along an exterior of the container body such that the rotor assemblies are contained within the at least one recess when the rotors assemblies are in the shipping configuration.

12. The method of claim 9, wherein the first destination is a delivery location and flying the UAV to the first destination comprises delivering the cargo to the delivery location.

13. The method of claim 9, wherein the second destination is a delivery location and shipping the container body of the UAV to the second destination comprises delivering the cargo to the delivery location.

14. The method of claim 9, wherein shipping the container body of the UAV to the second destination comprises shipping the body of the UAV to the second destination before flying the UAV to the first destination.

15. The method of claim 9, wherein:
flying the UAV to the first destination her comprises flying the UAV from the first destination to a group pickup station;
folding the rotor assemblies of the UAV into the shipping configuration comprises folding the rotor assemblies into the shipping configuration at the group pickup station; and
shipping the container body of the UAV to the second destination comprises shipping the body of the UAV from the group pickup station to the second destination.

16. The method of claim 9, further comprising sensing when the rotor assemblies of the UAV are in the shipping configuration and communicating that the container body of the UAV is ready to be shipped to the second destination.

17. A cargo delivery system comprising:
a base station; and
an unmanned aerial vehicle (UAV) comprising a container body having a cargo bay configured to hold cargo, the UAV comprising a plurality of rotor assemblies coupled to the container body and being configured to provide the container body with propulsion, the UAV comprising a control system held by the container body and operatively connected to the rotor assemblies, the control system being configured to fly the container body between the base station and delivery locations, wherein the rotor assemblies are moveable between a flight configuration and a shipping configuration, wherein in the flight configuration the rotor assemblies extend outward from the container body such that the rotor assemblies are positioned to propel the container body through the air, and wherein in the shipping configuration the rotor assemblies are folded to the container body such that the container body is configured to be shipped.

18. The cargo delivery system of claim 17, wherein the rotor assemblies of the UAV are contained within the cargo bay of the container body when the rotor assemblies are in the shipping configuration,

19. The cargo delivery system of claim 17, wherein the container body of the UAV comprises at least one recess extending along an exterior of the container body, the rotor assemblies being contained within the at least one recess when the rotor assemblies are in the shipping configuration.

20. The cargo delivery system of claim 17, wherein the control system of the UAV is communicatively coupled with the base station and is configured to automatically sense when the rotor assemblies are folded in the shipping configuration and communicate to the base station that the UAV is ready to be shipped.
